(19) United States
(12) Patent Application Publication
(10) Pub. No.: US 2023/0303003 A1
(43) Pub. Date: Sep. 28, 2023

(54) INTERIOR ACCESSORY FOR VEHICLE AND METHOD OF INSTALLING SAME

(71) Applicant: The MPW Irrevocable Trust, UTA, Las Vegas, NV (US)

(72) Inventor: Mitch P. Walk, Temecula, CA (US)

(21) Appl. No.: 18/188,068

(22) Filed: Mar. 22, 2023

Related U.S. Application Data
(60) Provisional application No. 63/269,751, filed on Mar. 22, 2022.

(51) Int. Cl. B60R 7/04

(52) U.S. Cl. CPC B60R 7/046

(57) ABSTRACT

An interior accessory for a vehicle includes a pouch. A pre-formed accessory fastener opening of the interior accessory receives a fastener that is received in a pre-formed fastener opening of an interior component of the vehicle to fasten the interior component to the vehicle. In this way, the interior accessory is attached to the interior accessory is attached to the interior component. The interior component may be a door panel or a center console, for example.

### CROSS-REFERENCE TO RELATED APPLICATIONS

The present application claims the benefit of U.S. Provisional Application No. 63/269,751, filed Mar. 22, 2022, the entirety of which is incorporated by reference.

### FIELD OF THE DISCLOSURE

The present disclosure generally relates to an interior accessory for a vehicle, such as a door panel accessory for a vehicle.

### BACKGROUND OF THE DISCLOSURE

Interior accessories may be used within a vehicle to add additional features for the driver and/or passengers. As discovered by the inventor of the present application, there is a need for such interior accessories to appear more integral to the interior of the vehicle.

### SUMMARY OF THE DISCLOSURE

In one aspect, a door for a vehicle generally comprises: a door body; an interior door panel defining at least one pre-formed panel fastener opening; a door panel accessory including a pouch, and at least one pre-formed accessory fastener opening; and at least one fastener extending through the pre-formed accessory fastener opening and into the preformed panel fastener opening to attach the door panel accessory to the interior door panel.

In another aspect, a method of installing an interior accessory within a vehicle generally comprises: providing the interior accessory, the interior accessory including a pouch, and at least one pre-formed accessory fastener opening; and attaching the interior accessory to an interior component of the vehicle by inserting at least one fastener through the at least one pre-formed accessory fastener opening and into at least one pre-formed interior fastener opening defined by interior component.

In yet another aspect, an interior accessory for a vehicle generally comprises: a pouch; a backing; and at least one pre-formed accessory fastener opening, wherein the at least one pre-formed accessory fastener opening is configured to receive at least one fastener configured to be received in a pre-formed fastener opening of an interior component of the vehicle to fasten the interior component to the vehicle.

### BRIEF DESCRIPTION OF THE DRAWINGS

FIG. 1 is a front elevational view of a first embodiment of a door panel accessory for a vehicle.

FIG. 2 is a front perspective view thereof.

FIG. 3 is rear perspective view thereof.

FIG. 4 is a right side elevational view thereof.

FIG. 5 is a left side elevational view thereof.

FIG. 6 is a top plan view thereof.

FIG. 7 is a bottom plan view thereof.

FIG. 8 is a front elevational view of a second embodiment of a door panel accessory for a vehicle.

FIG. 9 is a front perspective view thereof.

FIG. 10 is rear perspective view thereof.

FIG. 11 is a right side elevational view thereof.

FIG. 12 is a left side elevational view thereof.

FIG. 13 is a top plan view thereof.

FIG. 14 is a bottom plan view thereof.

FIG. 15 depicts the first embodiment of the door panel accessory secured to the vehicle door panel.

FIG. 16 depicts a pre-installed door panel accessory secured to the vehicle door panel to be replaced by the first embodiment of the door panel accessory.

FIG. 17 is a front elevation of a door panel accessory similar to the first embodiment described herein.

FIG. 18 is a rear elevation of the door panel accessory of FIG. 17.

FIG. 19 is a top perspective of the door panel accessory of FIG. 17.

FIG. 20 is a bottom perspective of the door panel accessory of FIG. 17.

FIG. 21 is a rear perspective of the door panel accessory of FIG. 17.

FIG. 22 is another embodiment of a door panel accessory.

FIG. 23 depicts another interior accessory secured to a door panel.

FIG. 24 depicts the interior accessory secured to a center console.

FIG. 25 is a front elevation of yet another embodiment of an interior accessory.

FIG. 26 is a rear elevation of the interior accessory of FIG. 25.

FIG. 27 depicts the interior accessory of FIG. 25 secured to a door.

FIG. 28 is a front elevation of yet another embodiment of an interior accessory secured to a center console.

FIG. 29 depicts installation of the interior accessory of FIG. 28 on the center console.

### DETAILED DESCRIPTION OF THE DISCLOSURE

In general, the present disclosure describes an interior accessory for a vehicle, such as a car, an SUV, a truck, etc. In one example, the accessory is configured to be secured to the interior door panel of a vehicle door, such as, but not limited to, the driver side door and/or the passenger side door and/or the rear doors. The door panel accessory provides additional storage for the user within the vehicle. The door panel accessory may be secured to the door panel using existing fasteners (e.g., bolts) and existing pre-formed openings or slots for the fasteners, or in other ways. The interior accessory may be configured to be secured to other components of the vehicle (e.g., center console) using pre-existing fasteners and pre-formed fastener openings.

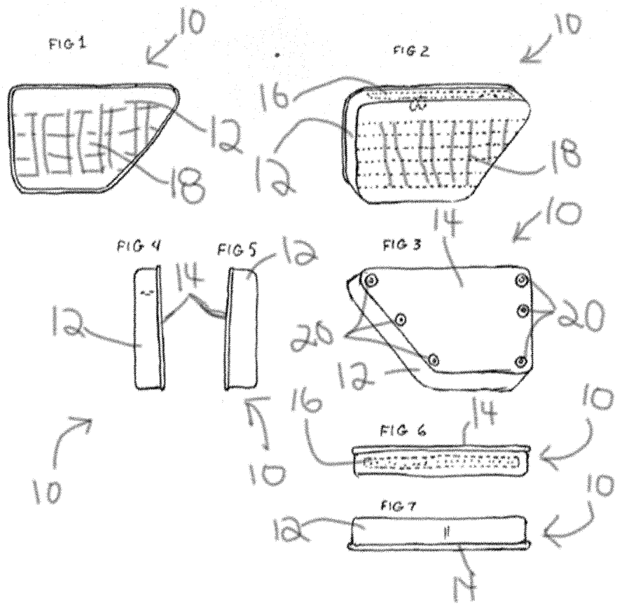

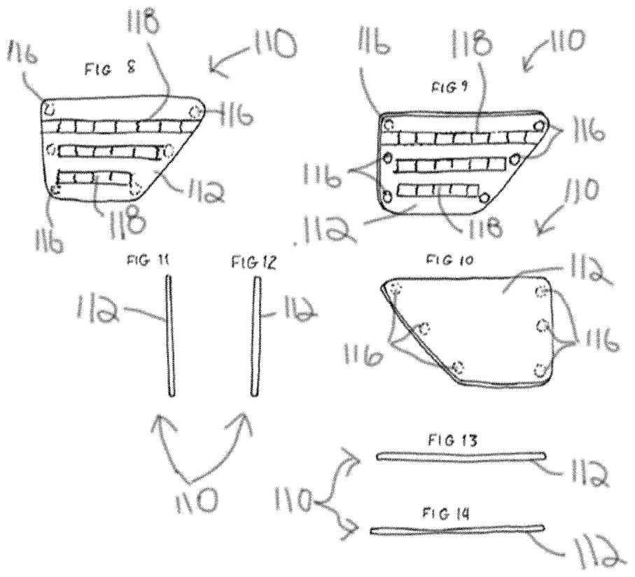

Referring now to the drawings, and in particular to FIGS. 1-7 and 15, a first embodiment of a door panel accessory for a vehicle is generally indicated at reference numeral 10. The door panel accessory 10 includes a pouch or bag 12 (e.g., a closable pouch or bag). The pouch 12 may be formed from a flexible material, such as fabric or plastic (e.g., vinyl). The door panel accessory 10 includes backing 14 (e.g., a back panel), and the pouch may be secured to the backing by sewing, ultrasonic welding, fasteners, or on other ways. In the illustrated embodiment, the pouch 12 is recloseable by a zipper 16 at an upper portion of the pouch. The zipper 16 may extend along the upper portion and the side portions to or adjacent to the lower portion of the pouch to allow front of the pouch to flap open. The pouch 12 may also be lockable, such as by including a lock that is securable to the zipper. In the illustrated embodiment, a front of the pouch 12 includes a PALS and/or MOLLE system 18 of overlapping straps or other structures to form loops suitable for holding tool, instruments, or other articles. The MOLLE front 18 can be made by sewing webbing, laser cutting, or can be plastic or other substrate with slots extending horizontally from one side to the other, and which can also secure webbing or other flexible or semi flexible materials to perform the function of securing MOLLE pouches and accessories. This pouch 12 may or may not have the PALS/MOLLE system, in which case, the accessory still allows much more space for protective storage.

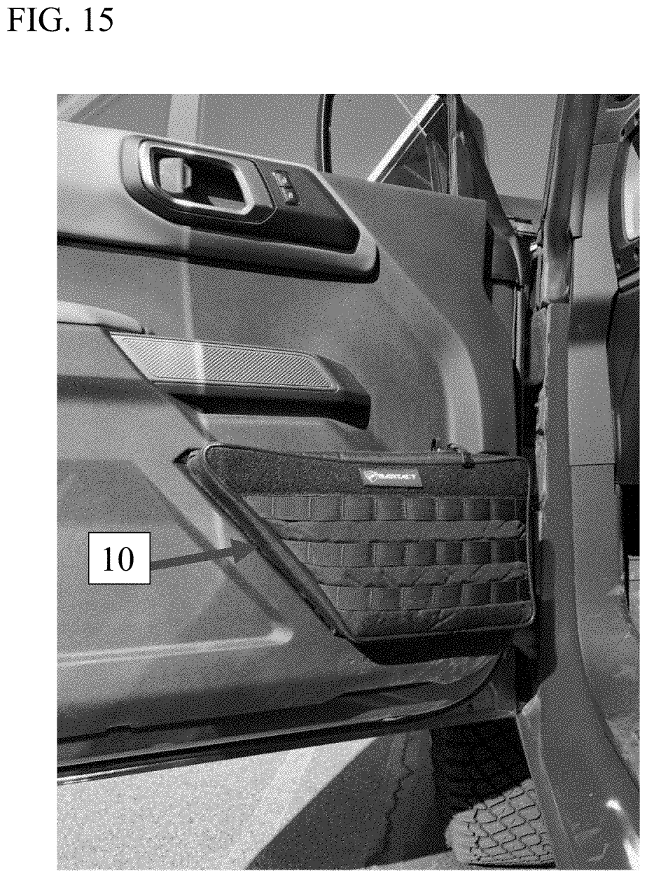

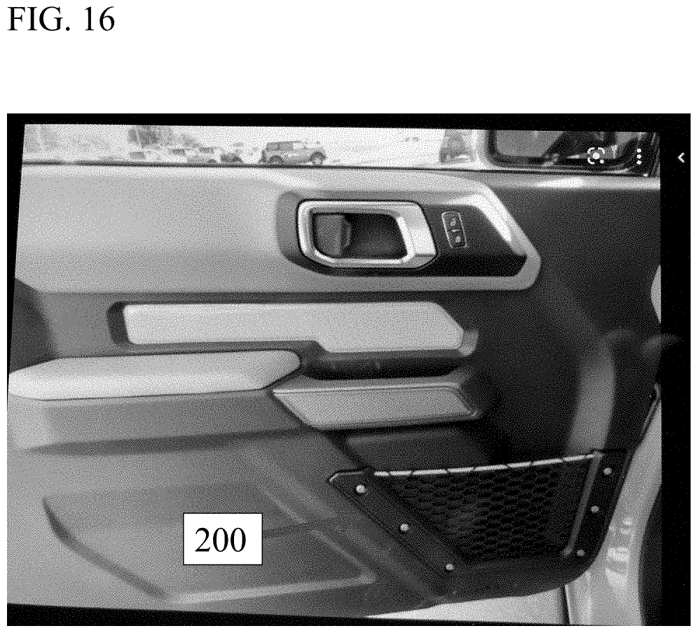

In one example, the backing 14 may be generally rigid (e.g., more rigid than the front panel of the pouch 12) and may be in the form a panel. For example, the backing 14 may be formed from plastic or other material. In another example, the backing 14 may be flexible, and similar to the remainder of the panels of the flexible pouch. The backing 14 (and the accessory in general) may have a footprint that is generally trapezoidal, although the footprint may be other shapes. In one example, the backing 14 is sized and shaped to generally correspond with a pre-existing door panel accessory so that the backing 14 fits within a recess on the door panel and/or appears to be assembled with the door panel, as can be seen from FIGS. 15 and 16. It is understood that the door panel accessory 10 may be retrofitted, such as can be seen from FIGS. 15 and 16, in which the pre-existing accessory, indicated at reference numeral 200 in FIG. 16, may be removed and replaced with the door panel accessory 10, or the door panel accessory is fastened over the pre-existing accessory. The backing 14 may define pre-formed fastener openings 20 (e.g., eyelets) that correspond to locations of the pre-formed fastener openings on the door panel so that fasteners may be inserted into the aligned openings to secure the door panel accessory 10 to the door panel. The openings 20 do not extend beyond the perimeter of the pouch such that the pouch is opened in order to insert the fasteners through the openings 20 and the heads of the fasteners are received in the pouch when secured to the door panel.

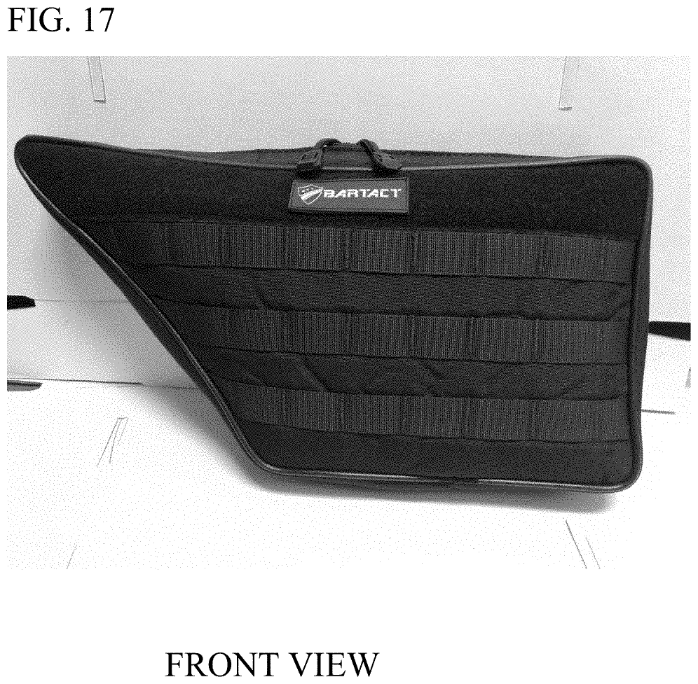

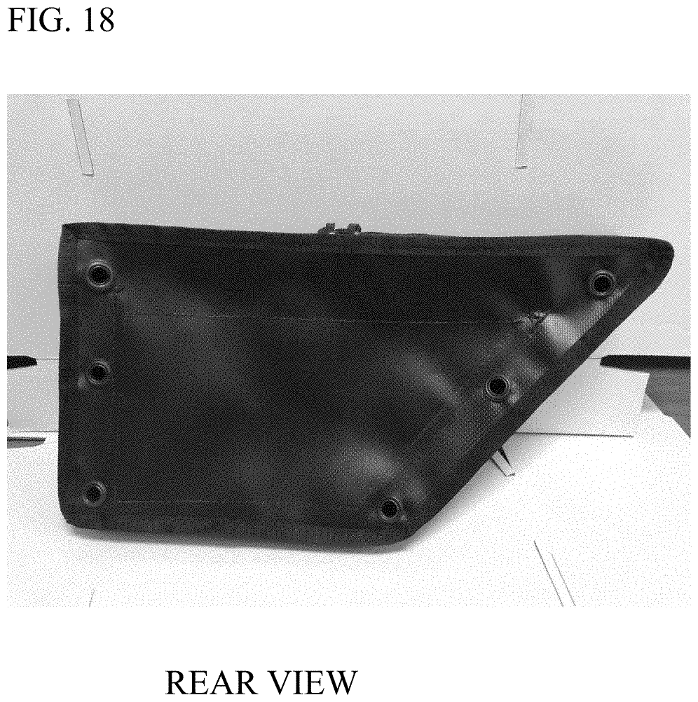

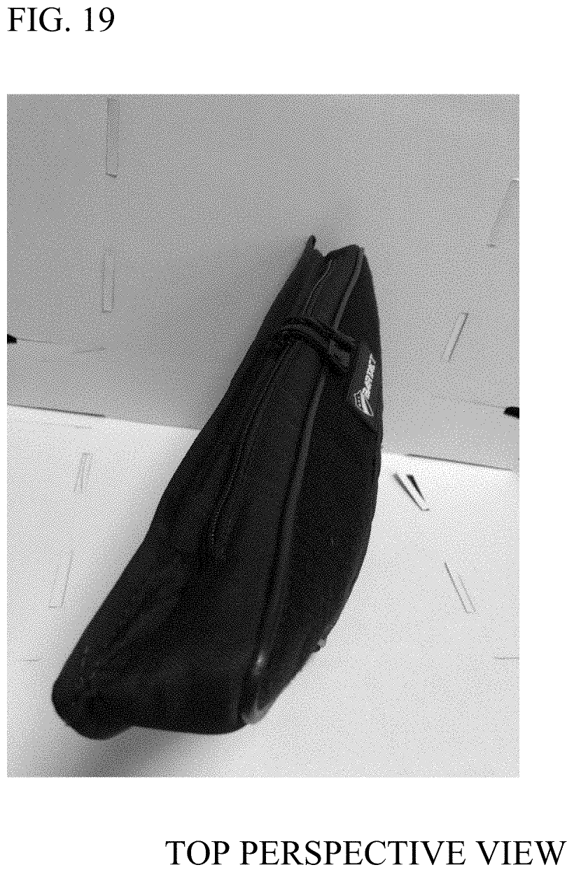

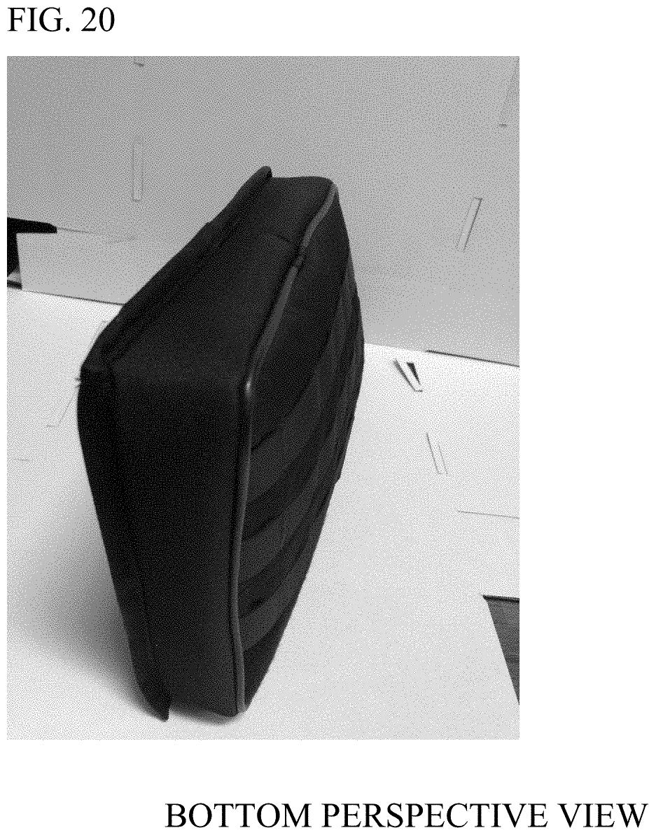

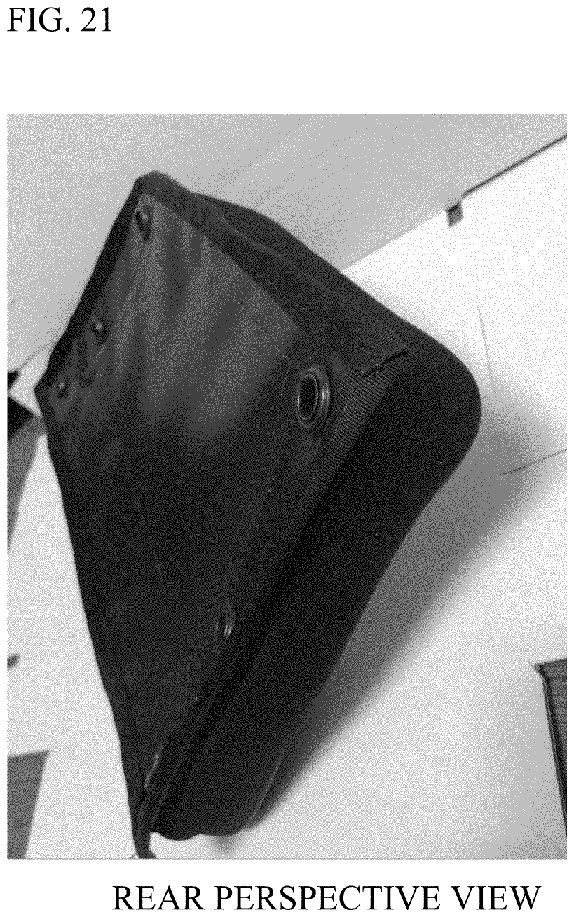

A suitable door panel accessory similar to the door panel accessory of FIGS. 1-7 is shown in FIGS. 15 and 17-21.

Referring to FIGS. 8-14, another embodiment of a door panel accessory for a vehicle is generally indicated at reference numeral 110. Unlike the first embodiment, the present embodiment does not include a bag or pouch. Instead, the door panel accessory 110 includes a panel 112, which may be similar to the backing 14. The panel 112 may be generally rigid or flexible like the pouch embodiment. The panel 112 may be formed from plastic or other material. The panel 112 (and the accessory in general) may have a footprint that is generally trapezoidal, although the footprint may be other shapes. In one example, the panel 112 is sized and shaped to generally correspond with a pre-existing door panel accessory so that the panel 112 fits within a recess on the door panel and/or appears to be assembled with the door panel, rather than retrofitted. It is understood that the door panel accessory 110 may be retrofitted. The panel 112 may define fastener openings 116 (e.g., eyelets) that correspond to fastener openings on the door panel so that fasteners may be inserted into the aligned openings to secure the door panel accessory 110 to the door panel.

The illustrated door panel accessory 110 further includes PALS and/or MOLLE system 118 of overlapping straps or other structures on a front of the panel 112 to form loops suitable for holding tool, instruments, or other articles. The MOLLE system 118 can be made by sewing webbing, laser cutting, or can be plastic or other substrate with slots extending horizontally from one side to the other, and which can also secure webbing or other flexible or semi flexible materials to perform the function of securing MOLLE pouches and accessories. For example, MOLLE Pouches, First Aid Kits, D-Rings, Swivel Hooks, Etc. may be secured to the MOLLE system. This modularity allows the user to pick and choose what items to keep readily at hand, rather than having a set area in which uses are limited. Other types of securement systems, other or in addition to a MOLLE and/or PALS system may be included on the panel 112.

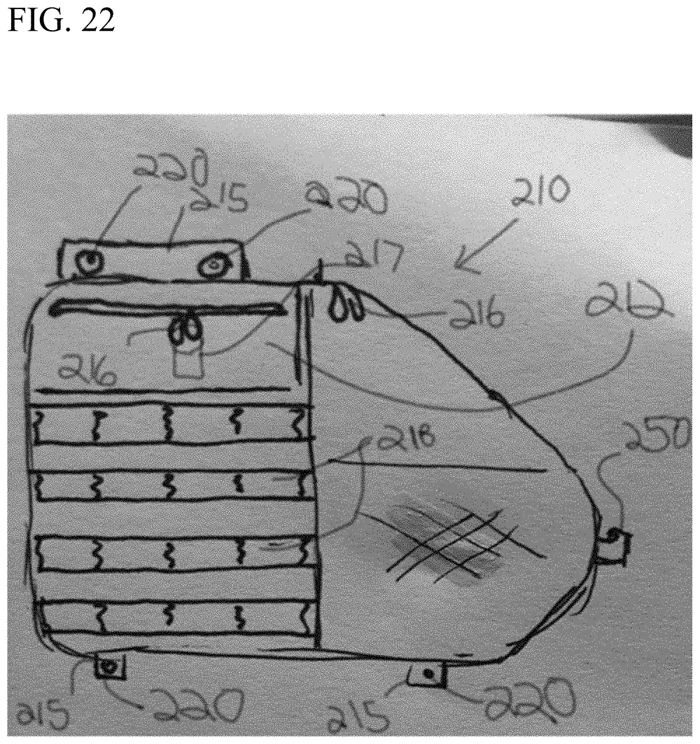

Referring to FIG. 22, another embodiment of a door panel accessory is generally indicated at reference numeral 210. This embodiment is similar to the first door panel accessory 10 in that a backing of a pouch 212 defines openings 220 (e.g., eyelets) that correspond to locations of fastener openings on a door panel (this door panel being different than the first door panel). A suitable door panel for this accessory 210 is shown in FIG. 27. In this embodiment, the openings 220 are not covered by the front of the pouch but instead are disposed on flanges or tabs 215 extending outward relative to the perimeter of the front of the pouch. It is understood that the openings 220 may be formed in the backing similar to the first embodiment. In addition, a J-hook 250 is secured to the pouch 212 to enable connection to a slot (not shown) on the door panel. The accessory 210 includes a zipper 216, a lock 217, and a MOLLE/PALS system 218 on the front.

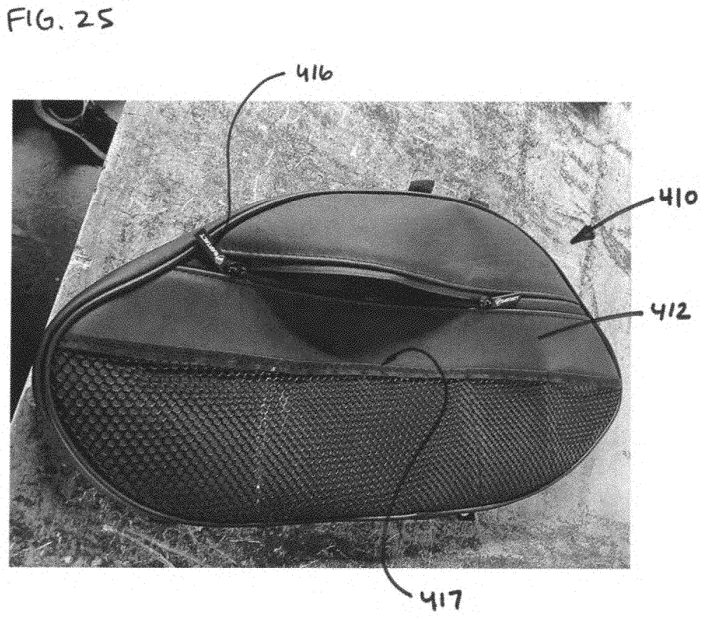

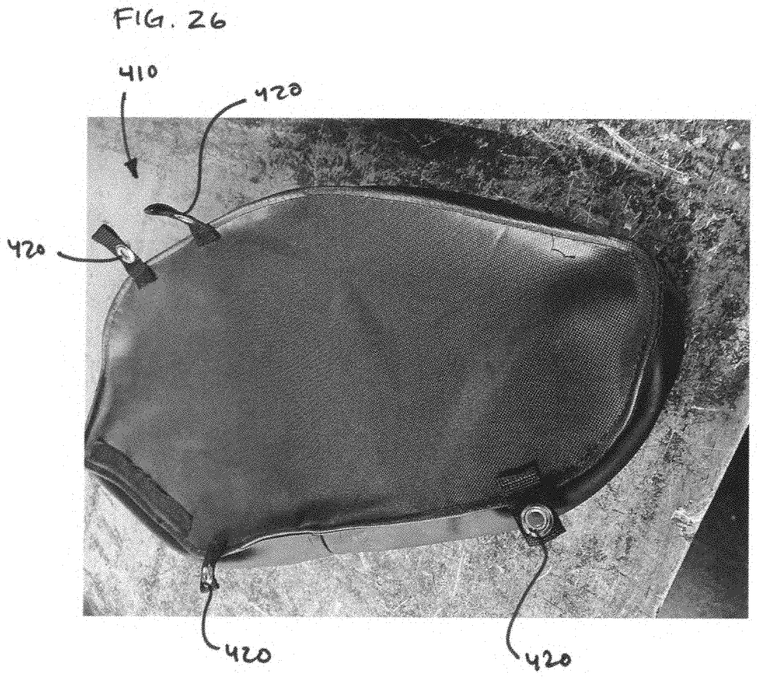

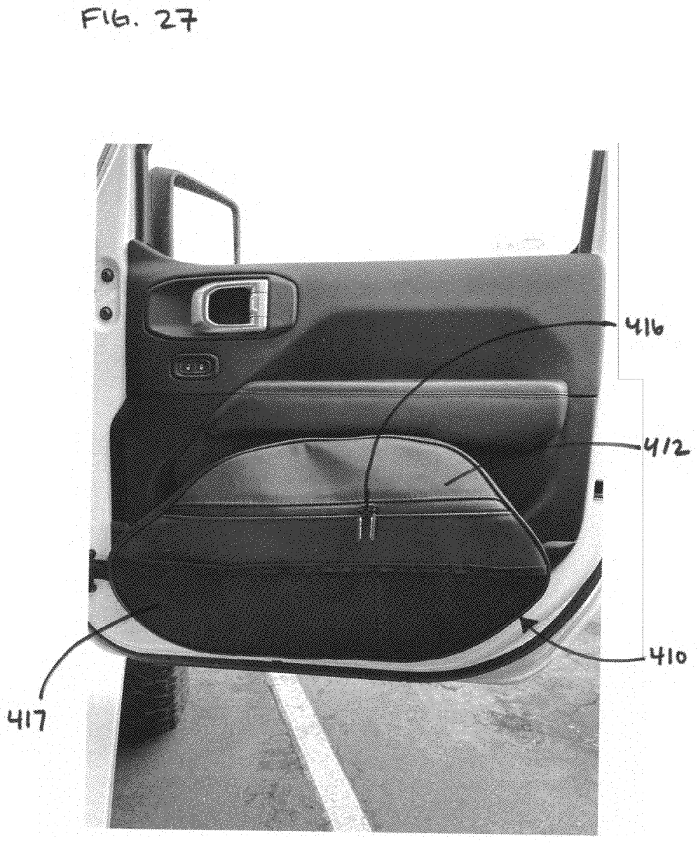

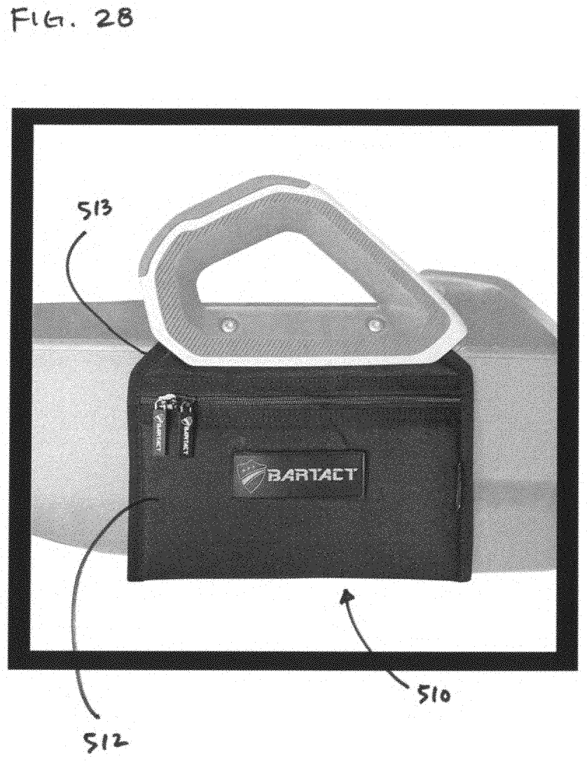

Referring to FIGS. 25-27, a door panel accessory similar to the door panel accessory 210 is generally indicated at reference numeral 410. FIG. 27 shows the door panel accessory 410 attached to the door panel to which the door panel accessory is configured to be secured to. This door panel accessory 410 includes a pouch 412 with a zipper 416, and a mesh pocket 417 on the front. As with the prior door panel accessory 210, The back panel shown in FIG. 26 defines the openings 420 (e.g., eyelets) that correspond to locations of fastener openings on the door panel. In the embodiment, the back panel may include a generally rigid structure or panel to enable the accessory 410 to retain its shape.

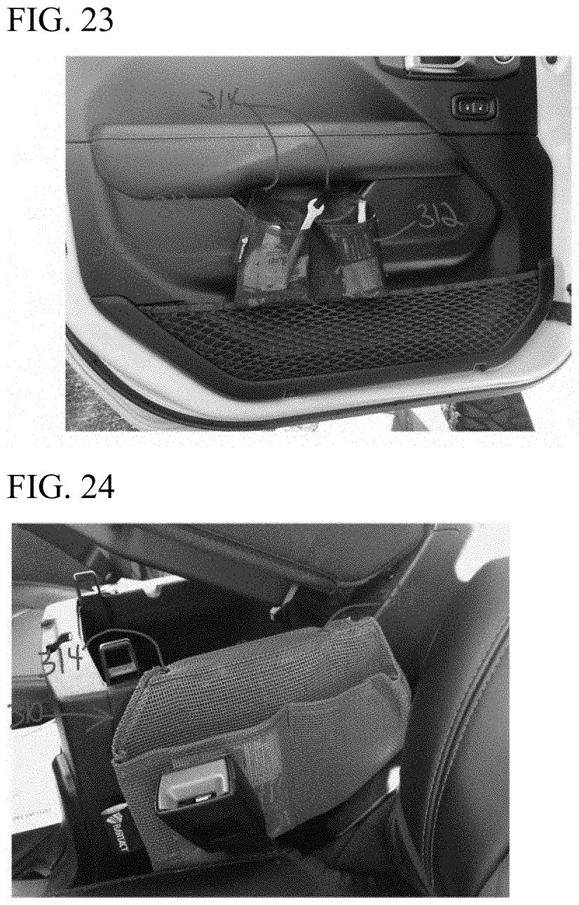

Referring to FIGS. 23 and 24, yet another embodiment of an interior accessory is indicated at reference numeral 310. This accessory 310 comprises at least one pouch 312 (e.g., one or more mesh pouches) for holding tool or other items. The mesh material of the accessory enables the fasteners 314 of the door panels to be extending through the material and into the corresponding openings in the door panel to secure the pouch to the door. The accessory 310 can be fastened to other components of the car other than the door panel, including but not limited to the center console, using existing fasteners, as shown in FIG. 24.

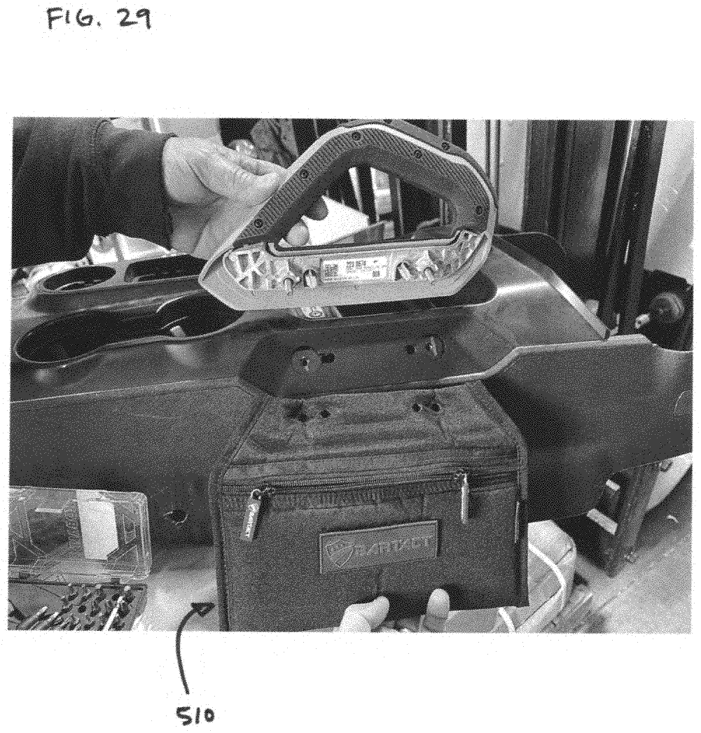

Referring to FIGS. 28 and 29, another embodiment of an interior accessory is indicated at reference numeral 510. This embodiment is similar to the interior accessory 310, in that this embodiment is configured to attach to a center counsel using existing fasteners. In this embodiment, the interior accessory 510 includes a pouch 512 and a flap or flange 513 defining openings 520 through which fasteners are received to attach the interior accessory to the console, for example. In this embodiment, there are four openings 520 through which fasteners that fasten a center console handle to the center console extend.

As can be appreciated from the above description, in one exemplary method the pre-existing fasteners are used to attach the interior accessory (e.g., door panel accessory and/or center console accessory) to the component of the vehicle. The fasteners are inserted through the pre-formed openings (e.g., eyelet) of the interior accessory and fastened to the interior component. In one particular embodiment, the interior accessory may be installed after-market or after assembly of the vehicle by removing the fasteners from the pre-formed fastener openings in the component, then inserting the fasteners through the pre-formed openings of the interior accessory and reinserting the fasteners into the component to attach the interior accessory to the component. In one embodiment, an existing interior accessory may be removed after removing the fasteners and replaced with the interior accessory of the present disclosure. In yet another embodiment, the existing interior accessory may remain in place and the interior accessory of the present disclosure may be installed over (e.g., overlie) the pre-existing interior accessory and the component.

Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A door for a vehicle comprising:
a door body;
an interior door panel defining at least one pre-formed panel fastener opening;
a door panel accessory including
a pouch, and
at least one pre-formed accessory fastener opening; and
at least one fastener extending through the pre-formed accessory fastener opening and into the preformed panel fastener opening to attach the door panel accessory to the interior door panel.

2. The door set forth in claim 1, wherein the door body defines at least one pre-formed body fastener opening, wherein the at least one fastener extends through the preformed panel fastener opening and into the preformed body fastener opening to further attach the door panel to the door body.

3. The door set forth in claim 1, wherein the door panel accessory overlies a portion of the interior door panel.

4. The door set forth in claim 1, wherein the at least one fastener comprises at least one bolt.

5. The door set forth in claim 1, wherein the pouch of the door panel accessory is at least partially formed from a flexible material.

6. The door set forth in claim 5, wherein the pouch includes a zipper for opening and closing the pouch.

7. The door set forth in claim 1, wherein the door panel accessory includes backing, wherein the backing defines the at least one pre-formed accessory fastener opening.

8. The door set forth in claim 7, wherein the backing includes a backing panel, wherein the backing panel defines the at least one pre-formed accessory fastener opening.

9. The door set forth in claim 7, wherein the backing includes a backing panel and at least one tab extending from the backing panel, wherein the at least one tab defines the at least one pre-formed accessory fastener opening.

10. A method of installing an interior accessory within a vehicle comprising:
providing the interior accessory, the interior accessory including a pouch, and at least one pre-formed accessory fastener opening; and
attaching the interior accessory to an interior component of the vehicle by inserting at least one fastener through the at least one pre-formed accessory fastener opening and into at least one pre-formed interior fastener opening defined by interior component.

11. The method of installing an interior accessory of claim 10, further comprising:
removing the at least one fastener from the at least one pre-formed interior fastener opening before said attaching the interior accessory to the interior component.

12. The method of installing an interior accessory of claim 11, further comprising:
removing an original interior accessory by said removing the at least one fastener, wherein said attaching the interior accessory replaces the original interior accessory.

13. The method of installing an interior accessory of claim 10, wherein the interior accessory is a door panel accessory, wherein the interior component is a door panel of the vehicle.

14. The method of installing an interior accessory of claim 10, wherein the interior accessory is a center console accessory, wherein the interior component is a center console of the vehicle.

15. An interior accessory for a vehicle comprising:
a pouch;
a backing; and
at least one pre-formed accessory fastener opening, wherein the at least one pre-formed accessory fastener opening is configured to receive at least one fastener configured to be received in a pre-formed fastener opening of an interior component of the vehicle to fasten the interior component to the vehicle.

16. The interior accessory set forth in claim 15, wherein the pouch includes a zipper to open and close the pouch.

17. The interior accessory set forth in claim 15, wherein the pouch is formed from flexible material.

18. The interior accessory set forth in claim 15, wherein the backing is relatively rigid to maintain a shape of the pouch.

19. The interior accessory set forth in claim 15, wherein the backing defines the at least one pre-formed accessory fastener opening.

20. The interior accessory set forth in claim 19, wherein the backing includes at least one eyelet defining the at least one pre-formed accessory fastener opening.
